(19) United States
(12) Patent Application Publication
(10) Pub. No.: US 2025/0118934 A1
(43) Pub. Date: Apr. 10, 2025

(54) CONNECTOR WITH PROTECTION MECHANISM

(71) Applicants: Austin Lai, Taichung City (TW); Chao-I Chien, Taichung City (TW)

(72) Inventors: Austin Lai, Taichung City (TW); Chao-I Chien, Taichung City (TW)

(73) Assignee: AVERTRONICS INC., Taichung City (TW)

(21) Appl. No.: 18/378,285

(22) Filed: Oct. 10, 2023

(51) Int. Cl. H01R 13/648; H01R 13/696

(52) U.S. Cl. CPC H01R 13/6485; H01R 13/696

(57) ABSTRACT

A connector with protection mechanism may include a first connector, and the first connector has a first terminal, a second terminal, and a protector. The first terminal and the second terminal respectively serve as positive and negative electrodes, and the protector is electrically connected to the first terminal or the second terminal. An indicator light is electrically connected between the first terminal and the second terminal, and when the first connector is in a conductive state, the indicator light lights up. A connector socket is sleeved outside of the first terminal and the second terminal, and the first terminal, the second terminal, the protector, the indicator light, and the connector socket are further covered by a connector sleeve to insulate and conceal the wiring, ensuring the protector is securely enclosed within the connector sleeve.

### FIELD OF THE INVENTION

The present invention relates to a connector and more particularly to a connector with protection mechanism that is reusable and allows for easy identification of electrical conductivity.

### BACKGROUND OF THE INVENTION

A connector is used for electrical current transmission, and especially when transmitting large current, as the current increases, it results in a corresponding increase in power, leading to elevated temperatures and the risk of overload. When temperatures rise due to overload, it can damage the wiring, and in extreme cases, even cause fires and significant hazards. Thus, in order to prevent such incidents in circuit connections, the fuses are connected in the circuit connection, and once the line overheats due to overload, the resistance in the fuse will be fused, resulting in a circuit break to prevent further accidents.

However, the conventional connector has following disadvantages: the mechanism of traditional fuses, as mentioned above, effectively prevents fire hazards by disconnecting the circuit when overloaded. However, the fuses need to be replaced and cannot be reused once the fuse melted during operation, and, additionally, the fuses are often embedded within connectors, replacing process becomes even more challenging and costing. Therefore, there remains a need for a new and improved design for a connector with protection mechanism to overcome the problems presented above.

### SUMMARY OF THE INVENTION

The present invention provides a connector with protection mechanism comprising a first connector, and the first connector has a first terminal, a second terminal, and a protector. The first terminal and the second terminal respectively serve as positive and negative electrodes, and the protector is electrically connected to the first terminal or the second terminal, and an indicator light is electrically connected between the first terminal and the second terminal, and when the first connector is in a conductive state, the indicator light lights up. A connector socket is sleeved outside of the first terminal and the second terminal, and the first terminal, the second terminal, the protector, the indicator light, and the connector socket are further covered by a connector sleeve to insulate and conceal the wiring, ensuring the protector is securely enclosed within the connector sleeve. The first connector is adapted to be connected to a mating connector, and the mating connector has two mating portions which are respectively and electrically connected to the first terminal and the second terminal. The protector is a self-resettable fuse, and the protector is in a conductive state under a default state. When the first connector is electrically connected to the mating connector and an overload is occurs, the protector is configured to interrupt the electric current, thereby achieving overload protection. The protector is adapted to automatically reset to a conductive state when not overloaded.

Comparing with conventional connector, the present invention is advantageous because: (i) the protector is a self-resettable fuse which is adapted to return to a conductive state when not overloaded, so as to enhance the convenience in use without manually replacing the protector by destroying the connector sleeve; (ii) when the first connector is in a conductive state, the indicator light lights up, so as to assist with lighting when the first connector needs to be electrically connected to the mating connector in poor lighting environments, thereby allowing the user to easily identify when the connector is conductive; and (iii) when the protector interrupts the current or the connector is not conductive, the indicator light goes off, providing the user with quick information.

### BRIEF DESCRIPTION OF THE DRAWINGS

FIG. 1 is a three-dimensional assembly view of a connector with protection mechanism of the present invention.

FIG. 2 is a three-dimensional exploded view of the connector with protection mechanism of the present invention.

FIG. 3 is a top view of the interior structure of the connector with protection mechanism of the present invention.

FIG. 4 is a schematic view illustrating a first connector is electrically connected to a mating connector in the present invention.

FIG. 5 is a schematic view illustrating the first connector is overloaded and shut off, and an indicator light of the first connector goes off in the present invention.

FIG. 6 is a schematic view illustrating the first connector is connected to a connector socket in the present invention.

FIG. 7 is a schematic view illustrating the first connector is enclosed within a connector sleeve in the present invention.

FIG. 8 is a front view of the connector with protection mechanism of the present invention.

FIG. 9 is a schematic view illustrating the connector with protection mechanism of the present invention is in use.

FIG. 10 is a top sectional view of a second embodiment of the connector with protection mechanism in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

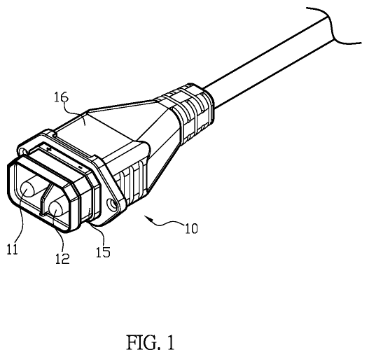

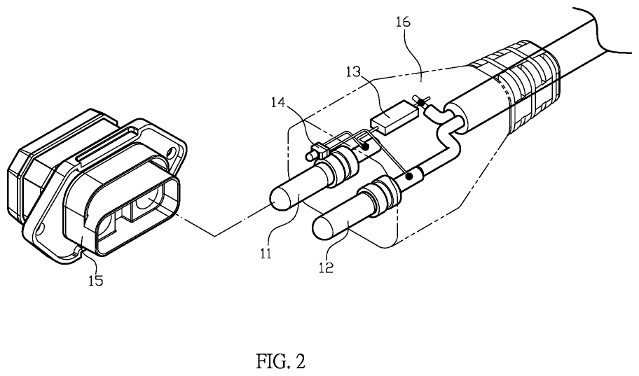

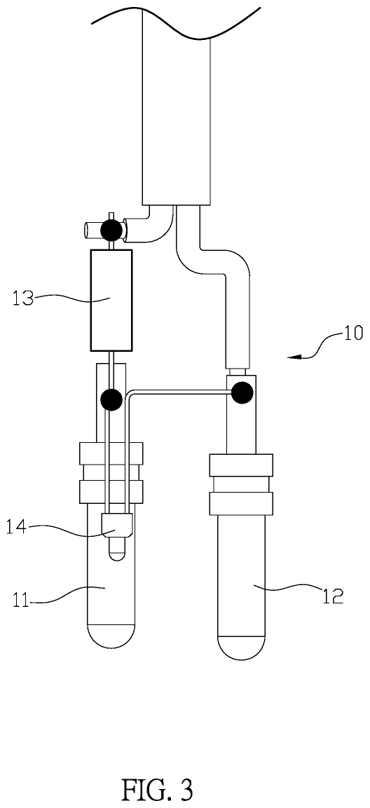

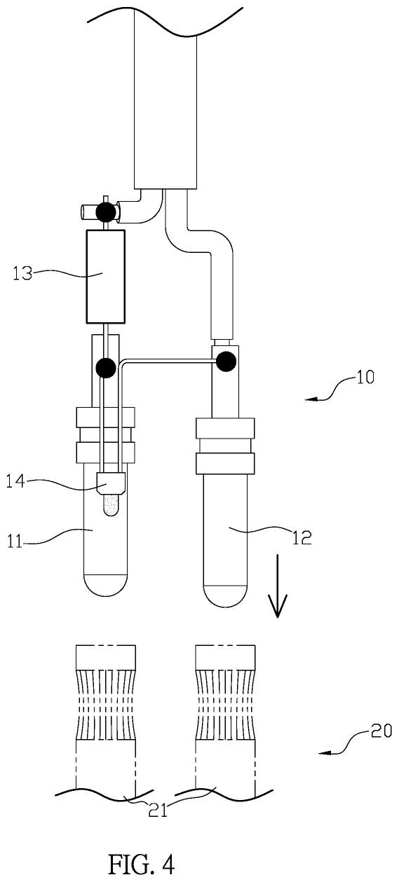

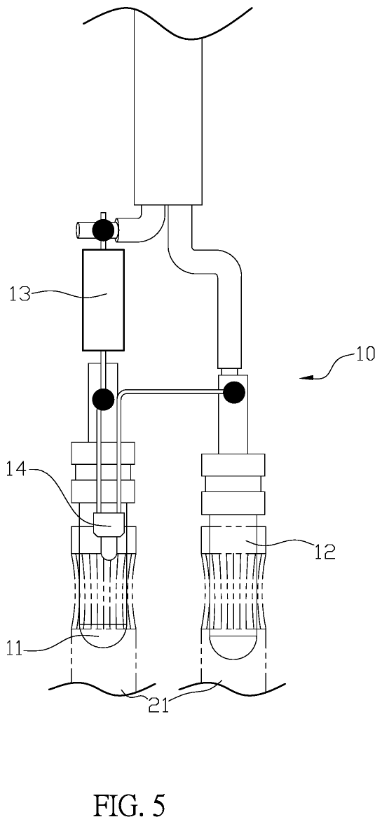

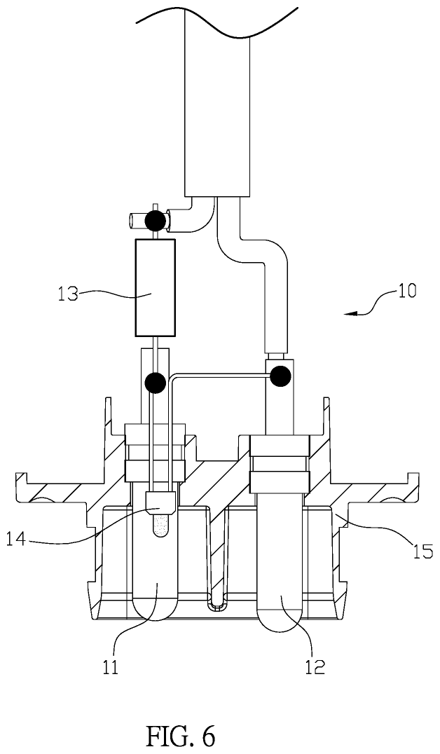

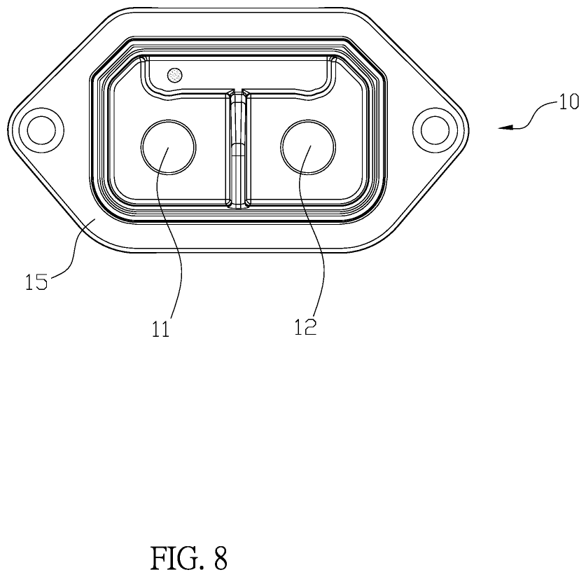

Referring to FIGS. 1 to 8, the present invention provides a connector with protection mechanism comprising a first connector (10), and the first connector (10) has a first terminal (11), a second terminal (12), and a protector (13). The first terminal (11) and the second terminal (12) respectively serve as positive and negative electrodes, and the protector (13) is electrically connected to the first terminal (11) or the second terminal (12), and an indicator light (14) is electrically connected between the first terminal (11) and the second terminal (12). A connector socket (15) is sleeved outside of the first terminal (11) and the second terminal (12), and the first terminal (11), the second terminal (12), the protector (13), the indicator light (14), and the connector socket (15) are further covered by a connector sleeve (16) to insulate and conceal the wiring, ensuring the protector (13) is securely enclosed within the connector sleeve (16). The first connector (10) is adapted to be connected to a mating connector (20), and the mating connector (20) has two mating portions (21) which are respectively and electrically connected to the first terminal (11) and the second terminal (12). The protector (13) is a self-resettable fuse, and the protector (13) is in a conductive state under a default state. When the first connector (10) is electrically connected to the mating connector (20) and an overload is occurs, the protector (13) is configured to interrupt the electric current, thereby achieving overload protection. Also, the protector (13) is adapted to automatically reset to a conductive state when not overloaded.

The protector (13) is a self-resettable fuse which is adapted to return to a conductive state when not overloaded, so as to enhance the convenience in use without manually replacing the protector (13) by destroying the connector sleeve (16).

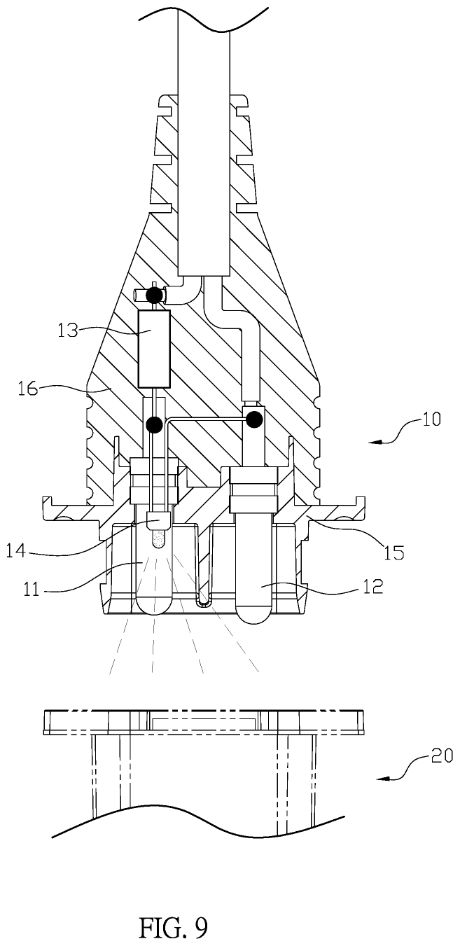

Referring to FIG. 9, in actual application, when the first connector (10) is in a conductive state, the indicator light (14) lights up, so as to assist with lighting when the first connector (10) needs to be electrically connected to the mating connector (20) in poor lighting environments. It also allows the user to easily identify when the first connector (10) is conductive. When the protector (13) interrupts the current or the first connector (10) is not conductive, the indicator light (14) goes off, providing the user with quick information.

In one embodiment, the first connector (10) is a male connector.

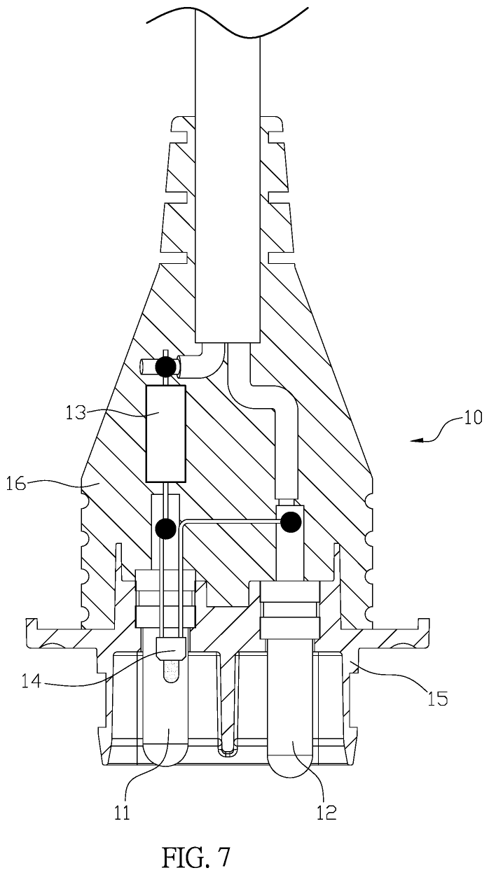

Referring to FIG. 7, the protector (13) is enclosed in a shell and further covered within the connector sleeve (16), so as to secure the position of the protector (13) and prevent the protector (13) from affecting the connector sleeve (16) due to the heating caused by the current.

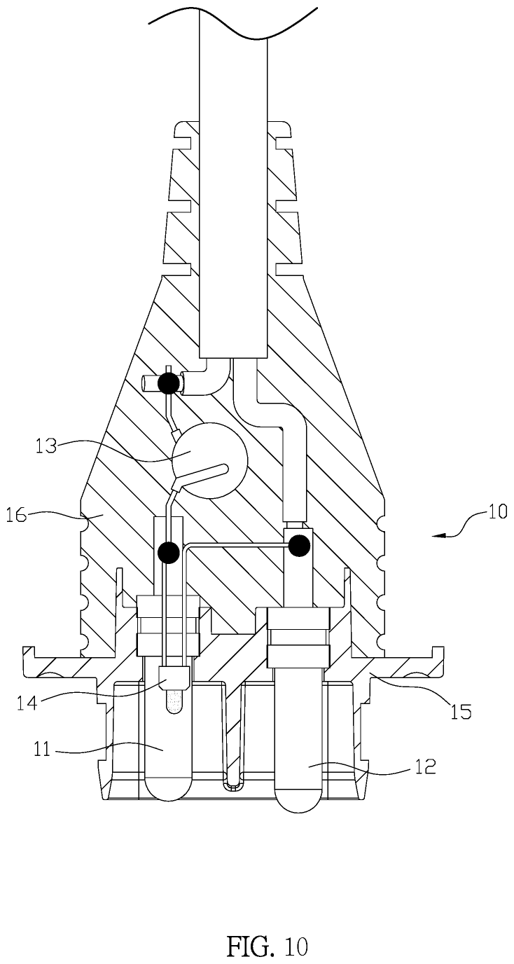

Referring to FIG. 10, in another embodiment, the protector (13) is directly enclosed within the connector sleeve (16).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A connector with protection mechanism comprising a first connector;
wherein the first connector has a first terminal, a second terminal, and a protector; the first terminal and the second terminal respectively serve as positive and negative electrodes, and the protector is electrically connected to the first terminal or the second terminal, and an indicator light is electrically connected between the first terminal and the second terminal, and when the first connector is in a conductive state, the indicator light lights up; a connector socket is sleeved outside of the first terminal and the second terminal, and the first terminal, the second terminal, the protector, the indicator light, and the connector socket are further covered by a connector sleeve to insulate and conceal the wiring, ensuring the protector is securely enclosed within the connector sleeve; the first connector is adapted to be connected to a mating connector, and the mating connector has two mating portions which are respectively and electrically connected to the first terminal and the second terminal; the protector is a self-resettable fuse, and the protector is in a conductive state under a default state; when the first connector is electrically connected to the mating connector and an overload is occurs, the protector is configured to interrupt the electric current, thereby achieving overload protection, and protector is adapted to automatically reset to a conductive state when not overloaded.

2. The connector with protection mechanism of claim 1, wherein the first connector is a male connector.

3. The connector with protection mechanism of claim 1, wherein the protector is enclosed in a shell, and the shell is covered within the connector sleeve.

4. The connector with protection mechanism of claim 1, wherein the protector is directly enclosed within the connector sleeve.
